(19) United States
(12) Patent Application Publication
(10) Pub. No.: US 2017/0261013 A1
(43) Pub. Date: Sep. 14, 2017

(54) ROTARY DRIVE AND BEVERAGE FILLING STATION

(71) Applicant: EVOGUARD GMBH, Nittenau (DE)

(72) Inventor: Johann JUSTL, Sinzing (DE)

(21) Appl. No.: 15/453,763

(22) Filed: Mar. 8, 2017

(30) Foreign Application Priority Data
Mar. 9, 2016 (DE) 10 2016 203 870.2

(51) Int. Cl. F15B 15/06; B67C 3/22; F16K 1/50

(52) U.S. Cl. CPC F15B 15/068; F16K 1/50; B67C 3/22; F16H 2025/2028

(57) ABSTRACT

In a rotary drive with a housing that contains a piston, a lid and a bottom, screw thread-like guiding grooves in the piston, a shaft with a rotary axis that can be rotated around an axis of the rotary drive and that encroaches in the guiding grooves, and axially parallel torque supports that are attached in the lid and/or bottom and that are embedded in guidances in the piston, with each torque support having an approximately rectangular external cross-section with a load-specific design to support torques to be transmitted and having longer rectangle sides tangentially to the shaft and shorter rectangle sides approximately in directions towards the axis.

### CROSS-REFERENCE TO RELATED APPLICATIONS

The present application claims priority to German Patent Application No. 10 2016 203 870.2, entitled “Rotary Drive and Beverage Filling Station,” filed on Mar. 9, 2016, the entire contents of which are hereby incorporated by reference for all purposes.

### TECHNICAL FIELD

The present disclosure relates to a rotary drive as well as to a beverage filling station.

### BACKGROUND AND SUMMARY

In rotary drives of this type, known from DE 19950582 C1 and DE 102010002621 A1, the torque supports have a circular external circumference. The guidances are cylindrical blind drills in the piston apron of the piston formed as a piston tube. The effective distance between each torque support and the axis of the rotary drive is relatively short due to the structural design because the blind drills require enough spacing to the external circumference of the piston. The torque supports are hollow or solid bars and consist of steel and are attached on the lid and/or the bottom for example through welding. High friction forces arise during transmission of the torques from the transversal axis via the guiding grooves, the piston and the torque supports into the lid and/or bottom of the housing. Furthermore, the bending resistance of the round torque supports is restricted in the effective direction of the torques and/or tangentially to the shaft of the rotary drive. Also the round attachment areas of the torque supports are subjected to excessive local tensions. As a whole, this reduces precision, results in high component stresses and only a moderate degree of efficiency.

The present disclosure is based on the purpose of creating a rotary drive of the type mentioned initially, with an increased degree of efficiency, inter alia between the torque support and the guidance, as well as a beverage filling station with improved properties of use.

The problem is solved with the features of a rotary drive with a housing that contains a piston that is displaceable in a linearly guided way, a lid and a bottom, screw thread-like guiding grooves in the piston, a shaft with a transversal axis, the shaft being in a bottom rotatable about an axis of the rotary drive and that encroaches in the guiding grooves in the piston, and at least one torque support, which is anchored in the housing, parallel to the axis and slidably fits in a guidance in the piston, to support torques generated by the transversal axis during displacement of the piston, wherein the respective torque support has an approximately rectangular external cross-section to support the torques load-specifically, which has longer rectangle sides tangentially to the shaft and shorter rectangle sides approximately radially to the axis.

The load-specific design of the torque support, e.g. its formation of a bridge profile or a bar, with a nearly rectangular external cross-section, whose longer rectangle sides are essentially tangential to the shaft and whose shorter, parallel rectangle sides are approximately positioned radially to the axis, results in an increased axial torque or bending resistance of the torque support. In addition, the radial effective distance between the planar area, in which the shorter rectangle sides interact with the guidance, and the axis of the rotary drive can be enlarged. This increases precision, reduces component stresses and increases the degree of efficiency. Also the attachment of the torque supports in the bottom and/or lid or bearing is more stable due to the load-specific design and transfers reaction forces from the torques to be transferred in a better way. Thanks to the load-specific design of the torque support, one torque support is basically sufficient. For safety reasons and due to lower specific surface pressures, two or more torque supports can still be provided. The respective torque support could also be attached exclusively or in addition on the inside of the housing.

Expediently, the longer rectangle sides are rounded convexly, optionally with a curvature that approximately corresponds to the external circumference curvature of the piston. The shorter rectangle sides can be straight and even or rounded convexly as well. This double convex external cross-section that is similar to a rectangle leads to a high bending resistance.

In an expedient embodiment, the guidance is an axial groove with a U-shaped cross-section in the external circumference of the piston that encompasses the torque support on three sides. The edges of the groove are for example parallel to the shorter parallel straight rectangle sides of the external cross-section of the torque support. The open groove is advantageous due to its manufacturing technique and results in an optimally high effective distance of the torque support in relation to the axis of the rotary drive. This, however, should not exclude the option of forming the guidances in the piston in a way that they are open towards the outside but with a closed channel cross-section that encompasses the external cross-section of the torque support on all four sides.

In an expedient embodiment, a gap is provided between the ground of the groove and one of the longer rectangle sides. The torque transmission is assigned exclusively to the short rectangle side and the edges of the guidance. The gap prevents unhelpful additional friction forces during displacement of the piston.

The external cross-section of the torque support can especially and for example be elliptical with the main axis of the ellipse being for example tangential to the shaft. In case of convex shorter rectangle sides, also the edges of the guidance in the piston circumference can be undercut in a respectively concave form. This results in a good guiding and a reduced surface pressure between the torque support and the guidance.

The torque support can be solid, for example made of steel, or hollow. Due to the high bending resistance, it can for example be formed of the same steel material as the bottom and/or the lid. Expediently, the respective torque support forms a one-piece casting, e.g. a precision casting stainless steel part, which is favorable in terms of manufacturing, with the lid and/or bottom and/or housing.

In an alternative embodiment, the torque support is welded on the bottom and/or lid or inside the housing. The torque support may have a pedestal that is widened with regard to the external cross-section in the direction of the longer rectangle sides and that is optionally welded on the entire circumference. This welding can be performed in an automated way without any problem.

It will further be advantageous if the torque support extends with an uncovered end beyond the axial position of the transversal axis into the piston in order to ensure an optimally long guiding length of the torque support in the guidance.

In one embodiment, the longer rectangle sides have for example approximately the double length of the shorter rectangle sides of the external cross-section.

Eventually, it is useful and cost-efficient to form the piston as a molded plastic part, for example as an injection-molded part. High-pressure polyamide or POM with fiber reinforcement is well suited for the piston.

The liners that are arranged on the transversal axis in an offset way in the circumferential direction in relation to the torque support are optionally cambered and the tracks of the guiding grooves are undercut. This is advantageous in two respects because cambering and undercutting increase the contact areas and therefore reduce the surface pressure with which torques are transmitted to the piston and because installation of the rotary drive is facilitated as no additional security elements are required for axial positioning of the liners on the transversal axis but as positioning is ensured by the form-fit between cambering and undercutting.

### BRIEF DESCRIPTION OF THE FIGURES

An embodiment of the object of the present disclosure is explained based on the drawing. The Figures show:

FIG. 1 shows a perspective view of a rotary drive installed on a shim valve, e.g. in a beverage filling station.

FIG. 2 shows a longitudinal section of the rotary drive.

FIG. 3 shows a side view of the rotary drive.

FIG. 4 shows a section view in the section plane IV-IV in FIG. 3.

FIG. 5 shows a partial section similar to FIG. 4.

FIG. 6 shows a side view related to FIG. 5.

### DETAILED DESCRIPTION

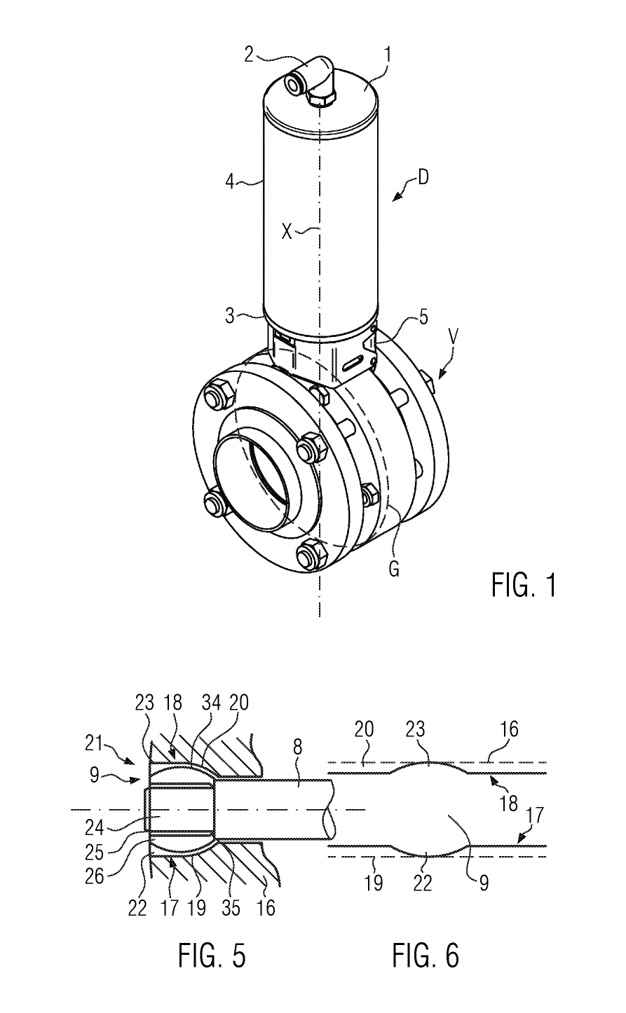

FIG. 1 illustrates as a non-restricting example a shim valve V, e.g. in a beverage filling station, with a closing organ that is not shown and that can be adjusted by means of a rotary drive D about an axis X over a swivel angle for example of approximately 90° between an open and a closing position.

The rotary drive D is installed with a pedestal 5 on the shim valve V and has a lid 1, a cylindrical housing 4 and a bottom 3. In the beverage filling station, the rotary drive D is controlled for example pneumatically via a connection 2 in the lid 1 against a spring that is not shown in FIG. 1.

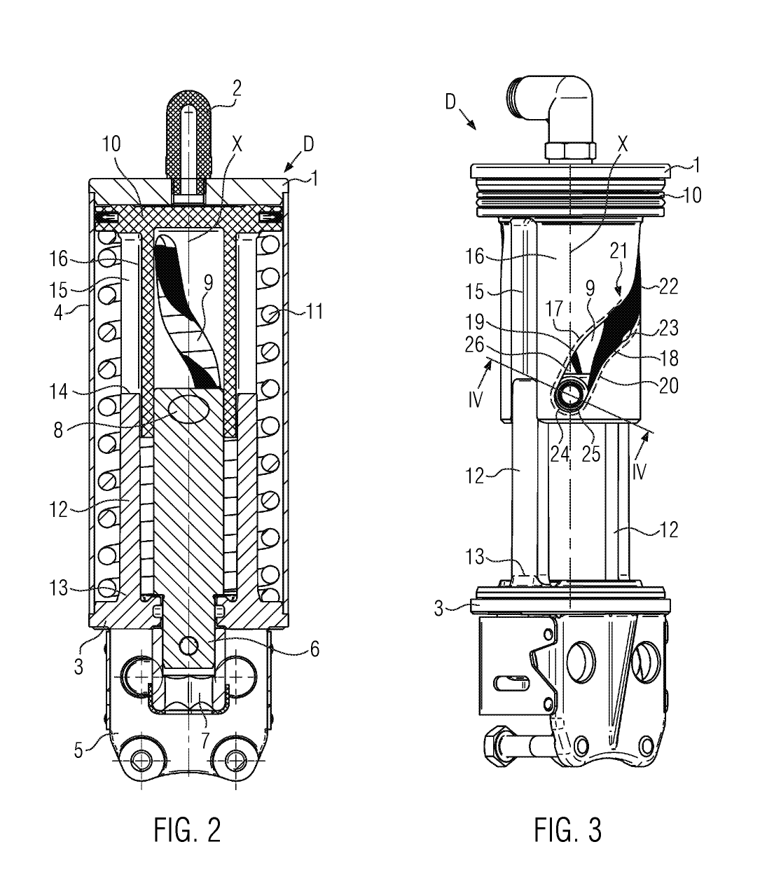

The longitudinal section view of FIG. 2 highlights that in the bottom 3, a shaft 6 is arranged rotatably around the axis X that extends upwards into the rotary drive D and that has a coupling part 7 on the lower end for the connection with the closing element of the shim valve V.

In the upper end of the shaft 6, a transversal axis 8 that is perpendicular to the axis X, which encroaches with its ends 24 (FIG. 3) in diametrically opposite, screw thread-like guiding grooves 9 in an apron 16 of a linearly guided piston 10 that is formed as a piston tube in this context, is specified. The piston 10 can here be moved in a sealed way in the housing 4 and is loaded by a spring 11. The piston 10 is actuated against the spring 11 or released by a pressurized means, for example pressurized air, via the connector 2 and moved back and forth in the direction of the axis X in this way, wherein the transversal axis 8 applies a rotary movement onto the shaft 6 in the guiding grooves 9. To enable the creation of this rotary movement, the piston 10 is supported in the housing 4 against rotation.

In the displayed embodiment, the support of the piston 10 is ensured by two (or more) torque supports 12 that extend from attachment points 13 at the bottom 3 upwards into guidances 15 of the piston apron 16 and that support the piston 10 against rotation and/or that transfer the torques, which are generated by the movement of the transversal axis 9 in the guiding grooves 9, into the bottom 3 that is connected in a stationary way to the shim valve V. Uncovered ends 14 of the torque supports 12 extend upwards, e.g. until over the position of the transversal axis 8. Alternatively, a torque support 12 could be attached on the bottom 3 and the other torque support 12 on the lid 1, wherein the uncovered ends 14 of the torque support 12 can then overlap at the height position of the transversal axis 8. In a further alternative, the torque supports could be attached only in the lid 1 or more than two axially parallel torque supports 12 and guidances 15 could be provided.

In alternatives of the rotary drive D that are not shown, only one torque support 12 and one guidance 15 could even be sufficient, or the torque support 12 can, only or in addition to the attachment in the bottom 3 or in the lid 1, be formed on or attached to the internal wall of the housing 4.

In the side view of the rotary drive D in FIG. 3, the housing 4 has been omitted for the sake of clarity and to illustrate the interaction among the torque supports 12 and the guidances 15 as well as the ends 24 of the transversal axis 8 and the guiding grooves 9.

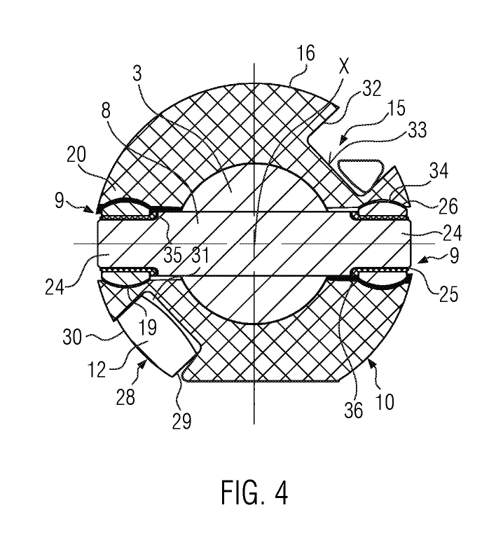

In the displayed embodiment, the guidances 15 for the torque supports 12 in the external circumference of the piston apron 16 are open, axially parallel grooves with a U-shaped cross-section, straight or even, parallel edges 32 (FIG. 4) and a groove ground 33 that is even and tangential to the axis X in this case. Alternatively, the guidances 15 could be closed on all four sides and encompass the torque supports 12 on all sides.

Each torque support 12 is formed load-specifically with regard to the torques and/or reaction forces from the torques to be transmitted in order to provide an optimally high bending resistance at an effective distance as long as possible to the axis X, which reduces the component stress. In detail, the torque support 12 has an approximately rectangular external cross-section with longer rectangle sides 28 that are tangential to the axis X and/or shaft 6 and shorter rectangle sides 29 that are essentially perpendicular to said longer rectangle sides and even in this case. The length ratio between the longer rectangle sides 28 and the shorter rectangle sides 29 can be approximately 2:1. The torque support 12 is for example a bridge or bar profile section.

In the shown embodiment, the longer rectangle sides 28 of the external cross-section are in addition cambered (at 30) and/or rounded convexly (alternatively in a double conical way) in order to further increase the bending resistance. Between the longer rectangle side 28 that points towards the axis X and the groove ground 33 of the guidance 15, a gap 31 can be provided to minimize contact surfaces that are in frictional contact to each other during torque transmission. Also the shorter rectangle side 29 could be rounded convexly so that the edges 32 of the groove could then be rounded in an accordingly concave way (approximately elliptical cross-section, not shown).

The bottom 3, pedestals 27 and the torque support 12 form a one-piece casting in FIG. 3, e.g. a precision casting made of stainless steel.

Each torque support 12 can have a pedestal 27, which is widened in an at least tangential direction to the axis X and/or the shaft 6, in FIG. 3 at the attachment point 13. The pedestal 27 can be welded to the bottom 3 in a welding structure of the rotary drive D. Alternatively, the torque support 12 could be inserted in an inlet of the bottom 3 and welded there, or set upon a mandrel of the bottom 3 and welded. In the displayed embodiment, the torque supports 12 are formed of steel and either solid or hollow. The steel can have approximately the same specification as the steel forming the bottom 3. Alternatively, a higher-grade steel than the one of the bottom 3 can be used for the torque support 12. The piston 10, in turn, can be made of plastic, for example high-pressure polyamide without or with fiber reinforcement or POM with reinforcement, and is for example a made-to-measure injection-molded part.

FIGS. 2, 3 and 4 illustrate in connection with FIGS. 5 and 6 the interaction between the transversal axis 8 and the screw thread-like guiding grooves 9 in the piston 19.

Each guiding groove 9 forms two tracks 17 and 18 that are opposite to one another for liners 26 that are arranged rotatably on the ends 24 of the transversal axis 8. Each liner 26 is installed with a bearing 25 (a plain bearing as shown; or a roller bearing as well as a needle bearing) on the end 24, wherein the bearing 25 can be attached firmly and in a torque-proof way on the end 24. The bearings 25 shown in FIG. 4 extend up to shoulders 35 between the ends 24 and the central part of the transversal axis 8 and have ring flanges 36 that protrude outwards in this area. The liner 26 is pushed onto the bearing 25 in the axial direction of the transversal axis 8 and is held axially positioned in its working position by the form-fit between a cambering system 34 on the circumference of the liner 26 and an undercut 19, 20 of the tracks 17, 18 of the guiding grooves 9 without the installation of additional machine elements being required for this purpose.

The cambering system 34 of the liners 26 is spherical in the displayed embodiment but can be double conical (not shown). The undercut 19, 20 of the tracks 17, 18 is either bent concavely in an arc section or double conical (not shown) in a way as to match the cambering system 34.

To be able to position the liners 26 during installation of the rotary drive D, the sides of the undercut 19, 20, which point towards the outside of the piston apron 16, are ablated in an arc-shaped way at 22, 23 in each guiding groove 9 in the area of the liner installation opening 21, expediently approximately in the middle between the guiding groove ends, i.e. in an area in which the torques to be transmitted are at a minimum level. The ablations 22, 23 are dimensioned accordingly on the external circumference of the liners 26 in order to be able to push to liners onto the ends 24. Alternatively, the liners 26 can be pre-installed with the bearings 25 and pushed or pressed loosely into their position. During operation of the rotary drive, the ablations 22, 23 are uncritical because the liners 26 can drive quickly over this area without the risk of slipping off, e.g. towards the outside.

The formation of a liner installation opening 21 is indicated in FIGS. 5 and 6. Each ablation 23, 22 reaches approximately up to half the depth of each undercut 19, 20 and enters the deepest area of the undercut 19, 20 essentially without any transition. The ablation 22, 23 is formed, according to FIG. 6, based on the circular external circumference of the liner 26. The ablations 22, 23 of both guiding grooves 9 are optionally positioned diametrically opposite in relation to the axis X to be able to install both liners 26 (with or without a bearing 25) in the same position of the piston 10 displaced accordingly against the force of the spring 11. The liners can be made of plastic or a metal or an alloy, matching the plastic material of the piston 10 with regard to the sliding and rolling properties.

The load-ances formation of the external cross-section of the torque support 12 and the matching guidances 15 increase the precision of the interaction, minimize the surface pressure and ensure a stable transmission of the torques into the bottom 3 (or the lid 1 and/or the housing 4). The form-fit between the cambering system 34 and the undercuts 19, 20, which positions the liners axially on the transversal axis 8, offers the advantage of a reduced surface pressure as the surfaces that are in contact with one another are increased, and simplifies installation as machine elements for axial securement of the liners 26 (with or without a bearing 25) are no longer required.

1. A rotary drive with a housing that contains a piston that is displaceable in a linearly guided way, a lid and a bottom, screw thread-like guiding grooves in the piston, a shaft with a transversal axis, the shaft being in the bottom and rotatable about an axis of the rotary drive and where the shaft encroaches in the guiding grooves in the piston, and at least one torque support, which is anchored in the housing, parallel to the axis and that slidably fits in a guidance in the piston, to support torques generated by the transversal axis during displacement of the piston, wherein the respective torque support has an approximately rectangular external cross-section to support the torques load-specifically, which has longer rectangle sides tangentially to the shaft and shorter rectangle sides approximately radially to the axis.

2. The rotary drive according to claim 1, wherein the longer rectangle sides of the external cross-section are rounded convexly, and wherein the shorter rectangle sides are either straight and parallel to one another or curved convexly.

3. The rotary drive according to claim 1, wherein the guidance is an axially open groove with a U-shaped cross-section in an external circumference of the piston that encompasses the torque support on three sides.

4. The rotary drive according to claim 3, wherein a gap is provided between a ground of the groove and the longer rectangle side that faces the ground.

5. The rotary drive according to claim 1, wherein the external cross-section of the torque support is approximately elliptical.

6. The rotary drive according to claim 5, wherein the guidance is an axially open groove in an external circumference of the piston, and wherein the rotary drive has concavely curved undercut groove edges that correspond to a convex curvature of the shorter rectangle sides.

7. The rotary drive according to claim 1, wherein the torque support is attached to the lid and/or the bottom and/or an internal wall of the housing.

8. The rotary drive according to claim 1, wherein at least two torque supports, which are positioned diametrically opposite to one another in relation to the shaft, are provided.

9. The rotary drive according to claim 1, wherein the torque support forms a one-piece casting with the bottom or the lid and/or with the housing.

10. The rotary drive according to claim 1, wherein the torque support is either solid or hollow.

11. The rotary drive according to claim 1, wherein the torque support consists of steel and is welded on the bottom made of steel and/or on the lid and/or inside the bearing.

12. The rotary drive according to claim 1, wherein the torque support extends with an uncovered end beyond an axial position of the transversal axis.

13. The rotary drive according to claim 1, wherein the longer rectangle sides are approximately twice as long as the shorter rectangle sides of the external cross-section.

14. The rotary drive according to claim 1, wherein the piston is a molded plastic part.

15. The rotary drive according to claim 1, wherein liners are arranged on the transversal axis in an offset way in relation to the torque support in the circumferential direction, which are cambered and that tracks that are provided for respectively one liner are undercut accordingly in the guiding grooves of the cambering or liners.

16. A beverage filling station with at least one shim valve having a rotary drive, the rotary drive comprising a housing that contains a piston that is displaceable in a linearly guided way, a lid and a bottom, screw thread-like guiding grooves in the piston, a shaft with a transversal axis, the shaft being in the bottom and rotatable about an axis of the rotary drive and where the shaft encroaches in the guiding grooves in the piston, and at least one torque support, which is anchored in the housing, parallel to the axis and that slidably fits in a guidance in the piston, to support torques generated by the transversal axis during displacement of the piston, wherein the respective torque support has an approximately rectangular external cross-section to support the torques load-specifically, which has longer rectangle sides tangentially to the shaft and shorter rectangle sides approximately radially to the axis.

17. The rotary drive according to claim 1, wherein the rotary drive is for a shim valve.

18. The rotary drive according to claim 2, wherein the longer rectangle sides of the external cross-section are rounded with a curvature that corresponds approximately to an external circumference curvature of the piston.

19. The rotary drive according to claim 14, wherein the piston is an injection molded part.
